(19) United States
(12) Patent Application Publication
(10) Pub. No.: US 2008/0299367 A1
(43) Pub. Date: Dec. 4, 2008

(54) AUTOMOTIVE INNER CEILING MATERIAL AND MOLDING METHOD THEREOF

(76) Inventor: Hisao Yamamoto, Osaka (JP)

Correspondence Address: BRINKS HOFER GILSON & LIONE, P.O. BOX 10395, CHICAGO, IL, 60610, US

(21) Appl. No.: 11/846,321

(22) Filed: Aug. 28, 2007

(30) Foreign Application Priority Data
Feb. 28, 2005 (JP) PCT/JP2005/003303

(51) Int. Cl. B60R 13/02; D04H 1/54; B29C 51/02

(52) U.S. Cl. 428/219; 442/364; 264/119

(57) ABSTRACT

The present invention provides an automotive inner ceiling material difficult to deform at a high temperature. Sheath-core type conjugate polyester fibers are prepared. The sheath is a heat fusible component. The core is a non heat fusible component. The sheath is made of copolyester which comprises acid units made of terephthalic acid and diol unites made of ethylene glycol and 1,4-butanediol. The conjugate fibers and the main fibers of polyester are mixed and provided in a card machine to be opened and accumulated to obtain a fibrous web. The fibrous web is heated to melt the sheaths, which are thereafter solidified to bind the fibers to obtain a non woven fabric. The nonwoven fabric is heat-treated at a temperature equal to or higher than the melting point of the sheath. Immediately thereafter, the nonwoven fabric is heat-molded between a pair of a mold plates. During the heat-molding process, the inner temperature is maintained at 100˜130° C. for 60 seconds to obtain the ceiling material.

### TECHNICAL FIELD

The present invention relates to an automotive inner ceiling material made of a nonwoven fabric. Especially, the invention relates to an automotive inner ceiling material being high in bending strength and small in thermal deformation.

### BACKGROUND ART

Conventionally, an automotive inner ceiling material comprises a nonwoven fabric, which is relatively thick and bulky, laminated with a surface material of woven or knitted fabric etc. and molded to fit onto the inner surface of the ceiling of an automobile. The bulky nonwoven fabric is preferably used as one of the automotive inner ceiling materials because it is superior in sound absorption, sound insulation and heat insulation. The bulky nonwoven fabric is generally made by the following process: A fibrous web is prepared by mixing main fibers and binder fibers which are heat adhesive. The fibrous web is heated and the binder fibers are melted or softened thereby bind the main fibers.

The automotive inner ceiling material is required to resist deformation at high temperatures, in addition to being superior in sound absorption etc. This requirement comes for the following reason: The temperature inside an automobile may become 80° C. or more under direct rays of the sun in summer. When the temperature becomes so high in the automobile, the automotive inner ceiling material made of the nonwoven fabric becomes softened, and the central part of the material is drooped by the weight thereof.

Therefore, the inventor of the present application proposed in Patent Reference 1 an automotive inner ceiling material which is resistive to deformation at high temperatures. That is, the inventor proposed the material made of the following nonwoven fabric: The nonwoven fabric is a mixture of main fibers made of polyester and sheath-core type conjugate fibers which each comprise a heat fusible sheath component made of copolymerized polyester and a non heat fusible core component made of polyester. The heat fusible sheath component is made of copolymerized polyester comprising acid units made of terephthalic acid and diol units made of ethylene glycol and 1,4-butanediol. The heat fusible sheath binds together the main fibers and the conjugate fibers.

Patent reference 1: JP2004-8108(TOKUGAN) [claim 1 and paragraph number 0002]

The nonwoven fabric described in the Patent Reference may be preferably prevented from deforming at a high temperature. However, some of the nonwoven fabrics molded may be prone to deform at a high temperature, depending on their molding conditions. The inventor of the present application investigated the molding conditions under which deformation at a high temperature may be prevented. As a result, the inventor has discovered that the automotive inner ceiling material which may resist deformation at high temperatures can obtained by maintaining the inner temperature of the nonwoven fabric at a certain temperature for a certain time period during the molding process. The invention was made on the basis of the above discovery.

### SUMMARY OF THE INVENTION

The invention relates to a molding method of an automotive inner ceiling material which comprises preparing a nonwoven fabric. The nonwoven fabric of the present invention is a mixture of main fibers made of polyester and sheath-core type conjugate fibers which comprises a heat fusible sheath component made of copolymerized polyester and a non-heat fusible core component made of polyester. The heat fusible sheath component comprises acid units made of terephthalic acid and diol units made of ethylene glycol and 1,4-butanediol. The nonwoven fabric is heat-treated at a temperature equal to or higher than the melting point of the heat fusible component. After the heat-treatment, the nonwoven fabric is heat-molded by pressing the nonwoven fabric with a pair of molding plates, while the inner temperature of the nonwoven fabric is maintained at 100˜130° C. for 60 seconds or more. The invention further relates to the automotive inner ceiling material obtained by the above molding method.

First, the nonwoven fabric according to the present invention will hereinafter be described. The nonwoven fabric is a mixture of main fibers made of polyester and sheath-core type conjugate fibers which each comprise a heat fusible sheath component made of copolymerized polyester and a non-heat fusible core component made of polyester. The polyester of which the main fibers are made is polymer units comprising ethylene terephthalate units, butylene terephthalate units or ethylene naphthalate units (especially, ethylene-2,6-naphthalate units). Especially, it may be preferable to use polyethylene terephthalate that is polyester comprising of ethylene terephthalate units, because the polyethylene terephthalate may be superior in sound absorption, sound insulation and exhibits resistance to deformation at high temperatures. To the degree not to degrade the resistivity against thermal deformation, the polyester may be copolymerized with other units comprising isophthalic acid units, 5-sulfoisophthalic acid units or diethylene glycol units etc.

The cross section of the main fiber may be circular in shape or may take other shapes. The main fibers may be either hollow fibers or non-hollow fibers and may have an arbitrarily selected fineness value as long as the main fiber has higher fineness and higher stiffness than the conjugate fiber. For instance, the fineness of the main fiber is generally about 3.3˜33 dtex. The length of the main fiber may be arbitrarily selected and therefore may be either staple fiber or continuous filament. The length of the main fiber is generally about 5˜100 mm, and is preferably about 20˜30 mm. The main fiber is generally a crimp fiber. The crimp fiber may be of either a two-dimensional wave configuration or a three-dimensional spiral configuration. The three-dimensional spiral configuration is preferable to obtain a bulky nonwoven fabric.

The sheath of the conjugate fiber is a heat fusible component. The core is a non-heat fusible component and provides a support. The sheath of the heat fusible component melts or softens under heat and binds the fibers. The heat fusible component is copolyester units which comprise acid units made of terephthalic acid and diol units made of ethylene glycol and 1,4-butanediol. The acid units and the diol units are mixed at an equal mol ratio and are copolymerized to obtain the copolyester. Preferably, the diol units may be mixed at some higher mol ratio than that of the acid units to adjust the degree of polymerization. The mol ratio of the ethylene glycol and 1,4-butanediol may be preferably 70˜10:25˜90 (ethylene glycol:1,4-butanediol). The diol units which have the above mol ratio are mixed with the acid units and copolymerized to obtain copolyester whose melting point is about 180˜210° C. If the melting point of the copolyester is lower than 180° C., the sheath tends to soften at a high temperature and deteriorates in binding effect, whereby the nonwoven fabric becomes prone to deform at a high temperature. If the melting point is higher than 210° C., the high heat energy is needed to melt or soften the sheath, and therefore, the main fibers tend to be damaged.

The heat of fusion applied to the copolyester may be preferably adjusted to 16 J/g or more. It is preferable that the heat of fusion is 16 J/g or more because the copolyester tends to become crystallized when solidified after melted. Such copolyester which tends to become crystallized may preferably used as the heat fusible component because crystallization of the heat fusible component is high when solidified after melted. Therefore, even if heat-treated at a high temperature, the problems may be prevented which result from the fact that crystallization of the heat fusible component is low. These problems include, for example, lowering of the binding strength and the bending strength of the nonwoven fabric and a thermal deformation of the nonwoven fabric.

The fineness of the conjugate fiber may be arbitrarily selected and may be generally 1.1˜22 dtex. The length of the conjugate fiber may also be arbitrarily selected and may be generally about 5˜100 mm, preferably about 20˜80 mm.

The mixture ratio of the main fibers and the conjugate fibers in the nonwoven fabric is about 20˜80:80˜20 (the main fibers: the conjugate fibers). The sheaths of the conjugate fibers bind the fibers when solidified after melted.

The thickness of the nonwoven fabric may be preferably 4˜20 mm. The thickness is measured under a no pressure condition. If the thickness is thinner than 4 mm, the sound absorption and sound insulation effect tends to become lower. The thickness of more than 20 mm is not preferable because the automobile having the nonwoven fabric tends to be weighty. The density of the nonwoven fabric may be preferably 0.03˜0.40 g/cm³. If the density is lower than 0.03 g/cm³, the sound absorption and sound insulation effect tends to become lower. The density of high than 0.40 g/cm³ is not preferable because the automobile having the nonwoven fabric tends to be weighty.

Such a nonwoven fabric, for example, may be made by the following method: A mixture of the main fibers and conjugate fibers are opened and accumulated through a carding machine to obtain a fibrous web. The fibrous web is heated through a heat treating machine as it is or after it goes through a needling process. By heating, the sheaths of the conjugate fibers melt or soften. When solidified, the sheaths bind the fibers to obtain the nonwoven fabric. As the heat treating machine, a hot blow circuit dryer, a hot blow flow through type dryer, a suction drum dryer or yankee drum dryer etc. may be used. The temperature and time of the heat treatment may be selected such that the sheath can melt or soften.

The nonwoven fabric is molded into a certain form to obtain an automotive inner ceiling material. First, the nonwoven fabric is heat-treated at a temperature equal to or higher than the melting point of the sheath. The nonwoven fabric may preferably be heat-treated under a non-pressure condition but may be heat-treated under some pressure condition. As a machine for the heat-treatment, the above-said dryer or an infrared heater may be used. After the heat-treatment, the nonwoven fabric is heat-molded by pressing it between a pair of molding plates which have predetermined shapes. In the present invention, the inner temperature of the nonwoven fabric or the temperature inside the nonwoven fabric is maintained at 100˜13° C. for 60 seconds or more, preferably 65 seconds or more, more preferably 70 seconds or more. The inner temperature of the nonwoven fabric means the temperature is measured with the sensor of a thermo meter which is inserted in the nonwoven fabric. For example, the sensor may be inserted in such a manner that a metallic stick or other stick which has a good heat conductivity and is U-shaped in cross-section or hollow is inserted toward the central part from a side (that is, the side of the thickness) of the nonwoven fabric. The sensor part is guided along the cave formed in the U-shaped section or hollow section of the metallic stick until the tip of the sensor becomes in contact with the fibers of the nonwoven fabric.

Various methods may be used to maintain the inner temperature at 100˜130° C. for 60 seconds or more. Generally, it is preferable to control the temperature of the pair of molding plates between which the nonwoven fabric is pressed. More specifically, if the surface temperature of the molding plates is maintained at about 90° C., the inner temperature is maintained at 100˜130° C. for a longer time. Metallic molding plates are generally used as the mold.

It is not preferable that the inner temperature is maintained at 100˜130° C. for less than 60 seconds because the bending strength and the resistivity against thermal deformation are lowered as understood from the below examples and comparative examples. The bending strength and the resistivity against thermal deformation may be lowered by the following reason: The heat fusible components made of copolymerized polymer are melted by the heat-treatment and then gradually solidified during the heat-molding process. If the time duration that the temperature during the solidifying process is maintained at 100˜130° C. is short, the degree of crystallization of the heat fusible components becomes low when solidified and thus the nonwoven fabric will be prone to soften at a high temperature. The present invention utilizes the characteristic that the degree of crystallization becomes high if the time duration that the temperature during the solidifying process is maintained at 100˜130° C. is longer than a certain time period.

In the present invention, heat-treated is the nonwoven fabric or the nonwoven fabric laminated with a surface material of any kind. The surface material may be laminated on one side or both sides of the nonwoven fabric. Woven or knitted fabric, plastic film or spun-bonded nonwoven fabric etc. may be used as the surface material.

The automotive inner ceiling material obtained in such a manner that the nonwoven fabric is heated at 100˜130° C. for a certain time period has the following properties: The bending strength of the inner ceiling material is 14.0 N/cm³ or more. If it is less than 14.0 N/cm³, the stiffness of the inner ceiling material is lowered, and the inner ceiling material is prone to deform. The thermal deformation is 16.0 mm or less at 100° C., and 22.0 mm or less at 130° C. When the thermal deformation is in the above range, the central part of the inner ceiling material is prevented from being dropped by the weight thereof even if the temperature inside an automobile becomes high. The bending strength and the thermal deformation are measured by the methods described in the below examples.

The automotive inner ceiling material according to the present invention has a sufficient bending strength. Therefore, the inner ceiling material is prevented from deforming even with a force applied from outside. The inner ceiling material has resistance to thermal deformation. Therefore, the central part of the inner ceiling material is prevented from being softened and drooped by the weight thereof even if the temperature exceeds 80° C. inside an automobile due to the direct rays of the sun in summer.

The molding method according to the invention can provide the automotive inner ceiling material which has sufficient bending strength and resistance to thermal deformation.

### BRIEF DESCRIPTION OF DRAWINGS

FIG. 1 is a typical view showing a method of measurement of bending strength.

FIG. 2 is a typical view showing a method of measurement of thermal deformation.

FIG. 3 is a graph showing changes of the inner temperature during the heat-molding process according to example 1.

FIG. 4 is an enlarged view showing a portion of FIG. 3 in which the inner temperature is maintaining at 100˜130° C.

### EXAMPLE

Hereinafter, the invention will be described on the basis of the examples. Please note, however, that the invention is not limited to the examples. It should be appreciated that the invention utilizes the specific property of copolyester and obtains the inner ceiling material which is prevented from deforming at a high temperature by maintaining the inner temperature of the nonwoven fabric at a certain temperature for a certain time period during a heat-molding process. A melting point, heat of fusion, bending strength and thermal deformation are measured as the following methods:

### (1) Melting Point (° C.):

The melting point was measured at a temperature rising at a speed of 20° C./min., using a differential scanning calorimeter DSC-2 produced by PerkinElmer Co., Ltd.

### (2) Heat of Fusion (J/g):

The heat of fusion was measured at a temperature rising at a speed of 20° C./min., using a differential scanning calorimeter DSC-2 produced by PerkinElmer Co., Ltd.

### (3) Bending Strength (N/cm):

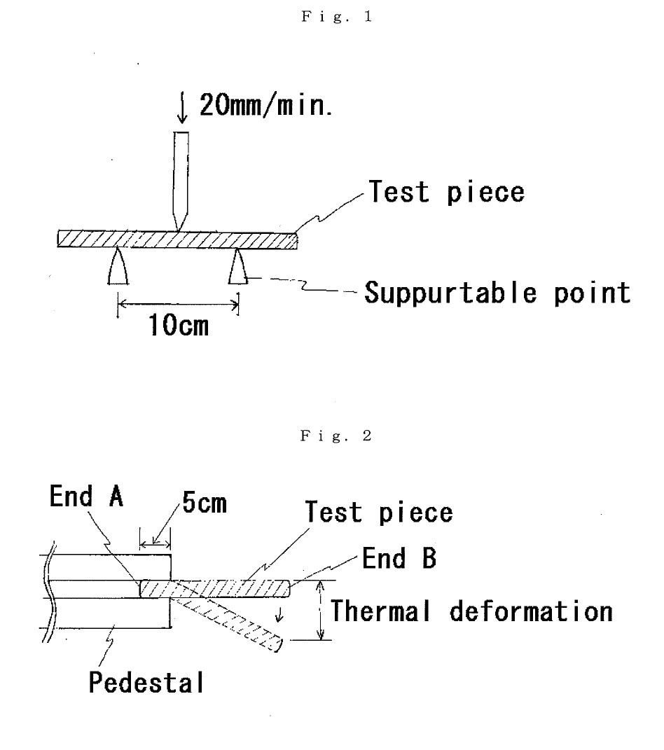

A test piece was prepared which has 5 cm in width and 20 cm in length. The test piece was put on two supportable points spaced apart by 10 cm. On the other hand, a steel plate was prepared which was equal to the test piece in width and had the end sharpened to 1.2 cm in thickness. The end of the steel plate was held above the test piece and was lowered at a speed of 20 mm/min. and was pushed onto the middle part of the test piece supported at the two points (FIG. 1.). When the test piece was bent, the maximum value of bending stress was read. And a bending strength was calculated with the following formula: The bending strength is indicated by a value of stiffness, and when the value is high, the test piece is high stiffness and difficult to bend. The bending strength as shown is an average of measurements conducted on 10 test pieces.

### [Formula]

Bending strength (N/cm²)=[3×(Maximum value of bending stress(N))×10 cm(distance between two supportable points)]/[2×5 cm(width of the test piece)×(Thickness of the test piece(cm²))²]

### (4) Thermal Deformation (mm):

A test piece was prepared which has 5 cm in width and 20 cm in length. The test piece was fixed on a pedestal at the point which is 5 cm from end A, and end B was left free. Under this condition, the test piece was left heated at 100° C. for 24 hours. After that, a degree of droop was measured from the first position of end B which was the position of the pedestal plus the thickness of the test piece (FIG. 2). The degree of droop was defined as thermal deformation at 100° C. A thermal deformation at 130° C. was likewise measured. That the thermal deformation value is small means that the test piece is resistive to deformation at high temperatures. The thermal deformation is an average of measurements conducted on 10 test pieces.

### Example 1

Dimethyl terephthalate was prepared as acid units. Diol units were also prepared in which ethylene glycol and 1,4-butanediol were mixed at an equal mol ratio. An interesterification and a polycondensation reaction were performed on the acid units and the diol units, wherein the amount of the diol units was 1.3 mol times greater than the acid units, to thereby obtain copolyester having the melting point of 182° C. and heat of fusion of 18.8 J/g. The copolyester and polyethylene terephthalate having the melting point of 225° C. were processed by a melt spinning machine so as to obtain sheath-core type conjugate polyester fibers having a fineness of 2.2 dtex and a length of 51 mm in which the copolyester became the sheaths and the polyethylene terephthalate became the cores at a sheath-core ratio equal to 1:1 (by weight).

On the other hand, polyethylene terephthalate fibers having a fineness of 17 dtex and a length of 51 mm in length (having the melding point of 225° C.) were prepared as main fibers. The main fibers and the above conjugate fibers were mixed at an equal ratio (50:50 by weight) and were provided in a carding machine to be opened and accumulated to thereby obtain a fibrous web.

The fibrous web was heated at 200° C. with no pressure thereon for 5 minutes in a hot blow circuit dryer in order to melt the sheaths of the sheath-core type conjugate fibers. The fibrous web was then brought out of the dryer and was cooled to obtain a nonwoven fabric in which the fibers were bound by the solidified sheaths (the heat fusible materials). The resulting nonwoven fabric was 800 g/m² in weight, 4 mm in thickness and 0.20 g/cm³ in density.

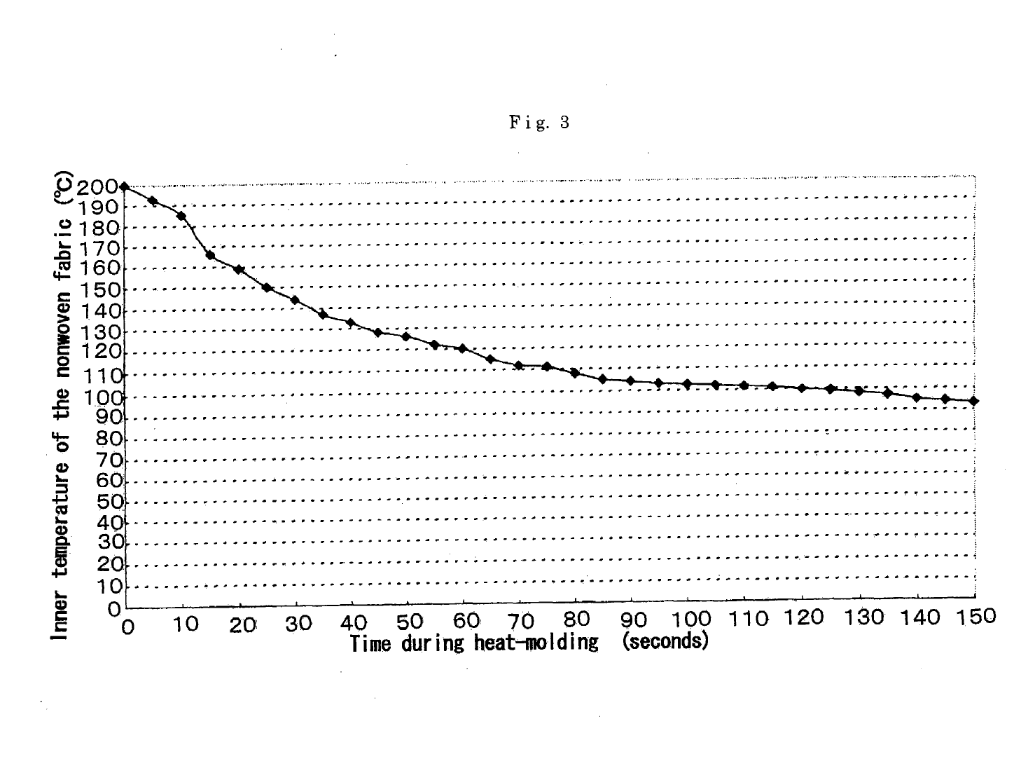

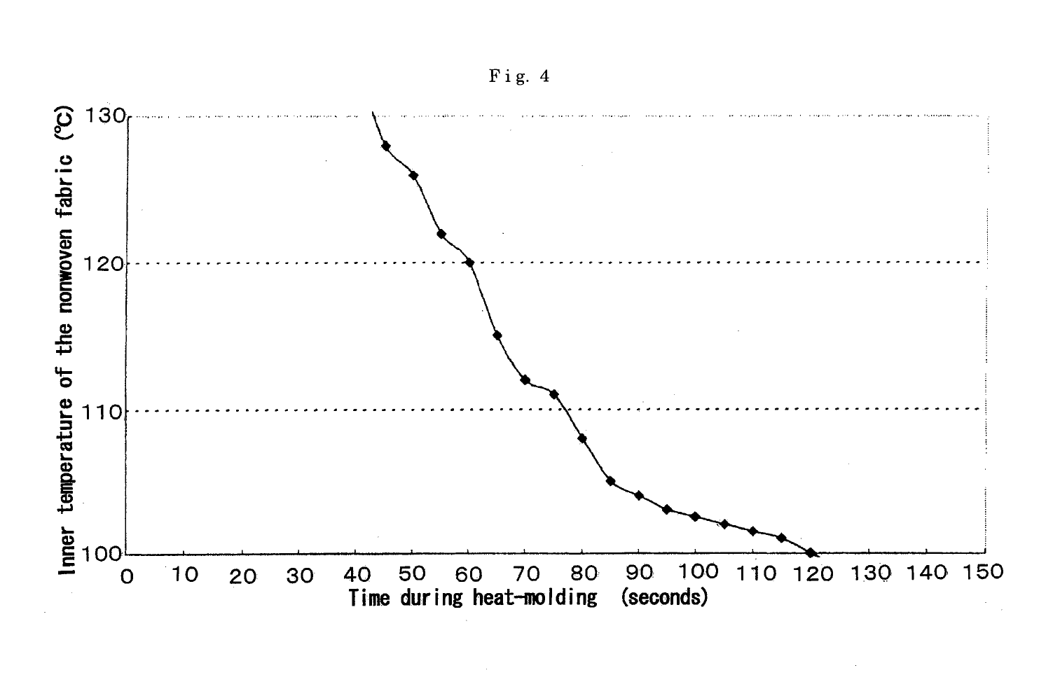

The nonwoven fabric was heat-treated at 200° C. under no pressure condition for 5 minutes in the hot blow circuit dryer. By this heat-treatment, the sheaths which had been solidified were again melted. Thereafter, the nonwoven fabric was heat-molded by a pair of heat press plates having a surface temperature of 90° C. for 150 seconds to obtain an automotive inner ceiling material. While the nonwoven fabric was being heat-molded by the heat press plates, the inner temperature of the nonwoven fabric was measured by the method described above. FIG. 3 and FIG. 4 show the results. The inner temperature was maintained at 100˜130° C. for 77 seconds. The type BS-31-TCI-ASP provided by Anritsu-Keiki co. was used as a thermo meter with a sensor.

### Comparative Example 1

Except that the temperature of the heat-treating the nonwoven fabric was changed to 170° C., an automotive inner ceiling material was prepared under the same conditions as used in example 1. The temperature was lower than the melting point of the sheath of the sheath-core type conjugate fibers made of polyester. Therefore, the sheaths binding the fibers were not melted and could not sufficiently be heat-molded. The inner temperature of the nonwoven fabric was maintained at 100˜130° C. for 60 seconds, which was shorter than that of example 1, because the inner temperature was 170° C. in the beginning of the heat-molding process.

### Comparative Example 2

Except that the surface temperature of the heat press plates was changed to 70° C., an automotive inner ceiling material was prepared under the same conditions as used in example 1. The inner temperature of the nonwoven fabric was maintained at 100˜130° C. for 44 seconds, because the surface temperature was low.

### Comparative Example 3

Except that the surface temperature of the pair of plates were changed to 50° C., an automotive inner ceiling material was prepared under the same conditions as used in example 1. The inner temperature of the nonwoven fabric was maintained at 100˜130° C. for 30 seconds, because the surface temperature was lower.

The bending strength and the thermal deformation at temperatures of 100° C. and 130° C. were measured on the inner ceiling materials prepared in example 1 and comparative examples 1˜3. The table 1 shows the results.

TABLE 1

| | |
|---|---|
| Bending | |
| strength | Heat deformation (mm) |

| | (N/cm²) | 100° C. | 130° C. |
|---|---|---|---|
| Example 1 | 160.3 | 14.5 | 20.3 |
| Comparative example 1 | 60.2 | 103.7 | 138.2 |
| Comparative example 2 | 98.4 | 15.2 | 21.1 |
| Comparative example 3 | 82.2 | 78.3 | 92.5 |

As shown in table 1, the ceiling material obtained in example 1 exhibited a high bending strength and a small thermal deformation as compared to the ceiling materials obtained in comparative examples 2 and 3. This is because the time duration that the inner temperature of the nonwoven fabric was maintained at 100˜130° C. was longer. The ceiling material obtained in the comparative example 1 exhibited a low bending strength and a greater thermal deformation. This is because the temperature at which the nonwoven fabric was heat-treated was lower than the melting point of the sheath. As a result, the nonwoven fabric was not sufficiently heat-molded.

What is claimed is:

1. An automotive inner ceiling material made by heat-molding a nonwoven fabric, said nonwoven fabric being a mixture of main fibers made of polyester and sheath-core type conjugate fibers which each comprise a heat fusible sheath component made of copolymerized polyester and a non-heat fusible core component made of polyester,
wherein said heat fusible sheath component is made of a copolymerized polyester comprising acid units made of terephthalic acid and diol units made of ethylene glycol and 1,4-butanediol and binds together said main fibers and said conjugate fibers, and
wherein said automotive inner ceiling material is 140.0 N/cm² or more in bending strength, and is 16.0 mm or less in thermal deformation at 100° C., and is 22.0 mm or less in thermal deformation at 130° C.

2. The automotive inner ceiling material according to claim 1 wherein the nonwoven fabric is 4˜20 mm in thickness and 0.03˜0.40 g/cm³ in density.

3. A molding method of an automotive inner ceiling material comprising of:
preparing a nonwoven fabric which is a mixture of main fibers made of polyester and sheath-core type conjugate fibers which each comprise a heat fusible sheath component made of copolymerized polyester and a non heat fusible core component made of polyester,
wherein said heat fusible sheath component is made of copolymerized polyester comprising acid units made of terephthalic acid and diol units made of ethylene glycol and 1,4-butanediol and bonds together said main fibers made of polyester and said conjugate fibers made of polyester;
heat-treating said nonwoven fabric at a temperature which is equal to or higher than a melting point of said heat fusible sheath component; and
after said heat-treatment, heat-molding said nonwoven fabric by pressing it with a pair of molding plates, while an inner temperature of said nonwoven fabric is maintained at 130˜160° C. for 60 seconds or more.

4. The molding method of an automotive inner ceiling material according to claim 3 wherein the nonwoven fabric is 4˜20 mm in thickness and 0.03˜0.40 g/cm³ in density.
